(19) United States
(12) Patent Application Publication
(10) Pub. No.: US 2010/0015479 A1
(43) Pub. Date: Jan. 21, 2010

(54) ASSEMBLY FOR PRODUCING A HYDROGENOUS GAS

(76) Inventors: Klaus Rusch, Gersthofen (DE); Marco Ranalli, Augsburg (DE)

Correspondence Address: PAMELA A. KACHUR, 950 W 450 S, BLDG. 4, COLUMBUS, IN, 47201, US

(21) Appl. No.: 12/302,936

(22) PCT Filed: May 15, 2007
(86) PCT No.: PCT/EP2007/004339

§ 371 Date: May 5, 2009

(30) Foreign Application Priority Data
Jun. 1, 2006 (DE) 10 2006 025 664.6

(51) Int. Cl. H01M 8/18

(52) U.S. Cl. 429/19

(57) ABSTRACT

An assembly for producing a hydrogenous gas has a reformation device with a fuel supply, a gas supply, and a catalytic converter. A vaporization unit is arranged upstream of the catalytic converter of the reformation device with respect to the gas flow and has a heating element arranged in a chamber for vaporizing a fuel. The vapor is guided into the gas flow and a preheating device for the fuel is arranged upstream of the chamber and configured as a heat exchanger.

### RELATED APPLICATIONS

The application is the U.S. National Phase of PCT/EP2007/004339 filed 15 May 2007, which claimed priority to German Application 10 2006 025 664.6 filed 1 Jun. 2006.

### TECHNICAL FIELD

The invention relates to an assembly for producing a hydrogenous gas.

### BACKGROUND OF THE INVENTION

There exists a wide variety of possible uses for hydrogenous gas, such as in a fuel cell, as a fuel for a combustion engine or for the regeneration of an exhaust gas purification system, for example of a NO,-storage catalytic converter or a particulate filter in the exhaust system of a Diesel or lean mixture engine. Hydrogenous gas can be produced on the basis of a fuel-air-mixture using a reformation device (for example a so-called POX-catalytic converter or an autothermal reformer) by decomposing the mixture into a hydrogen-enriched gas in a catalytic converter of the reformation device.

It became apparent that it is unfavorable to supply the fuel directly in a liquid form to the reformation device because the temperature prevailing in the reformation device greatly decreases, at least in an inlet region of the liquid, owing to the thermal energy needed for vaporizing the fuel. The amount of energy provided by the reformation device is possibly insufficient to completely vaporize the fuel before it enters the catalytic converter (also referred to as a reaction chamber or a reactor) and to thus obtain a good mixture with the air. In particular in a start-up phase, it is therefore necessary to preheat the reformation device before the fuel can be admitted. A further known solution is to basically vaporize the fuel outside of the catalytic converter of the reformation device using an external heat source, which however increases the energy consumption.

### SUMMARY OF THE INVENTION

In contrast thereto, the invention provides an assembly for producing a hydrogenous gas, which distinguishes itself by a particularly low energy consumption.

According to the invention, an assembly for producing a hydrogenous gas is provided for this purpose. The assembly includes a reformation device that has a fuel supply and a gas supply, and a vaporization unit that is arranged upstream of a catalytic converter of the reformation device with respect to the gas flow. The vaporization unit has a heating element for vaporizing a fuel arranged in a chamber, the vapor being guided into the gas flow, and a preheating device for the fuel which is arranged upstream of the chamber and is configured as a heat exchanger. The fuel is heated and even completely vaporized mainly by the heat exchanger. The heating element is used only when needed, for example in a start-up phase of the combustion engine or of the reformation device during which the heat exchanger cannot provide energy at all or cannot provide the energy that is needed. In this way, primarily the energy already present in the system is used, and the additional heating element is used only when needed.

The gas supply is in particular an air supply.

The heating element is preferably an electrical heating element, in particular a glow plug. This glow plug is available at particularly low costs as a mass-produced article.

According to one embodiment, the heat exchanger is exposed to the gas flow which passes through the reformation device. The heat exchanger can be placed within the reformation device itself or downstream of the reformation device in an appropriate place in the hydrogenous gas flow, that is in the exhaust gas of the reformation device. It is also conceivable to place the heat exchanger upstream of the reformation device, for example in the preheated air flow.

The heat exchanger is preferably placed in the reformation device downstream of the catalytic converter or in the catalytic converter, which is for example a partial oxidation catalytic converter (POX). In both arrangements, the energy released during the reaction is used to vaporize the fuel that is to be supplied to the reformation device.

If a fuel cell is arranged downstream of the reformation device, the heat exchanger can also be placed in the region of this fuel cell, in particular upstream of a cold fuel cell or downstream of a hot fuel cell.

When using the hydrogenous gas for the regeneration of an exhaust gas purification system, the heat exchanger is preferably placed in the associated exhaust branch of a combustion engine.

However, it has to be noted generally that the heat exchanger can be arranged at any point where the energy needed is available.

According to one embodiment, at least one control is provided which controls the heating element for releasing the heat quantity still needed for the vaporization, in particular depending on the fuel mass flow and the fuel temperature. A particularly efficient system is obtained in this way. If the heating element is an electrical heating element, the control controls the power supply thereof.

A temperature sensor coupled to the control should be provided between the heat exchanger and the heating element. The heat quantity that is still to be supplied to the fuel is determined on the basis of the data acquired by the temperature sensor.

According to a further development of the invention, an ignition device for the fuel-air-mixture supplied to the reformation device is provided between the vaporizing unit and the reformation means. The ignition means can be, e.g., a spark plug, an arc, or a ceramic glow pencil (MIMS).

These and other features of the present invention can be best understood from the following specification and drawings, the following of which is a brief description.

### BRIEF DESCRIPTION OF THE DRAWINGS

FIG. 1 shows a schematic illustration of an assembly according to the invention for producing a hydrogenous gas.

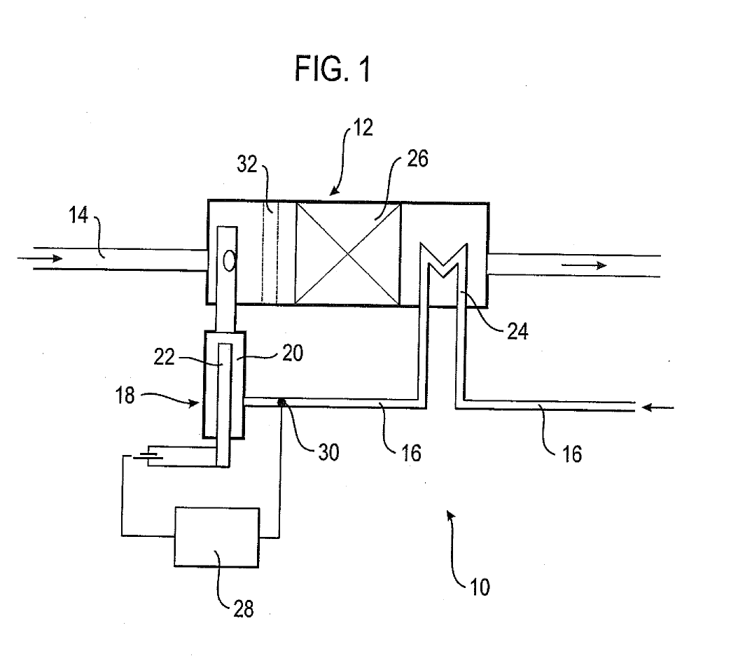

FIG. 2 shows a perspective view of the heating device for the fuel, which is configured as an intermediate flange insert.

### DETAILED DESCRIPTION OF THE PREFERRED EMBODIMENT

An assembly 10 for producing a hydrogenous gas comprises a reformation device 12 having a gas supply 14 in the form of an air supply, and a fuel supply 16. A vaporization unit 18 is arranged in the fuel supply 16 and includes an electrical heating element 22, in the present case a glow plug, which is placed in a chamber 20. Alternatively, a ceramic glow pencil (MIMS) can be used as a heating element 22. The vaporization unit 18 is thus located upstream of a catalytic converter 26 of the reformation device 12 with respect to the gas flow passing through the reformation device 12. The catalytic converter is in particular a partial oxidation catalytic converter (POX).

Arranged upstream of the chamber 20 is a preheating device for the fuel in the form of a heat exchanger 24, which is placed in the reformation device 12 downstream of the catalytic converter 26 in the embodiment shown. The heat exchanger 24 is thus exposed to the gas flow which passes through the reformation device 12. Unlike the arrangement shown, the heat exchanger 24 can also be placed in the region of a fuel cell arranged downstream of the reformation device 12. In case the assembly 10 according to the invention is used in combination with a combustion engine, either for providing a hydrogen-enriched fuel for the combustion engine, or for producing a reducing agent for the regeneration of an associated exhaust gas purification device, the heat exchanger 24 can also be placed in the region of the combustion engine, in particular in the exhaust branch thereof.

A control 28 is furthermore provided which is coupled to a temperature sensor 30 arranged between the heat exchanger 24 and the heating element 22 in the fuel supply 16.

During operation, the reformation device 12 is supplied with (possibly preheated) fresh air via the gas supply 14, and with vaporous fuel via the fuel supply 16 (or the vaporization unit 18), which are mixed with each other. A partial oxidation of the fuel occurs in the catalytic converter 26, during which hydrogen is liberated. The vaporization of the initially liquid fuel occurs mainly in the heat exchanger 24. The heat quantity, which is possibly still needed for the complete vaporization of the fuel, is determined in the control 28 on the basis of the data acquired by the temperature sensor 30 and depending on the mass flow in the fuel supply 16. The control 28 controls a power supply of the heating element 22 depending on the determined heat quantity; the fuel which reaches the chamber 20 in a liquid state is then completely vaporized by the heating element 22 before entering the reformation device 12. The vaporization unit 18 is therefore employed in particular in a cold start-up phase of the reformation device 12.

To quickly bring the reformation device 12 to the reaction temperature and/or stabilize the system, an ignition device 32 for the fuel-air mixture, such as a spark plug, an arc, or a ceramic glow pencil, can optionally be provided between the vaporization unit 18 and the reformation device 12 (or the catalytic converter 26).

Unlike the configuration shown, the reformation device can be a so-called autothermal reformer which, additionally to the partial oxidation section, includes a vapor reformation section and a water vapor supply.

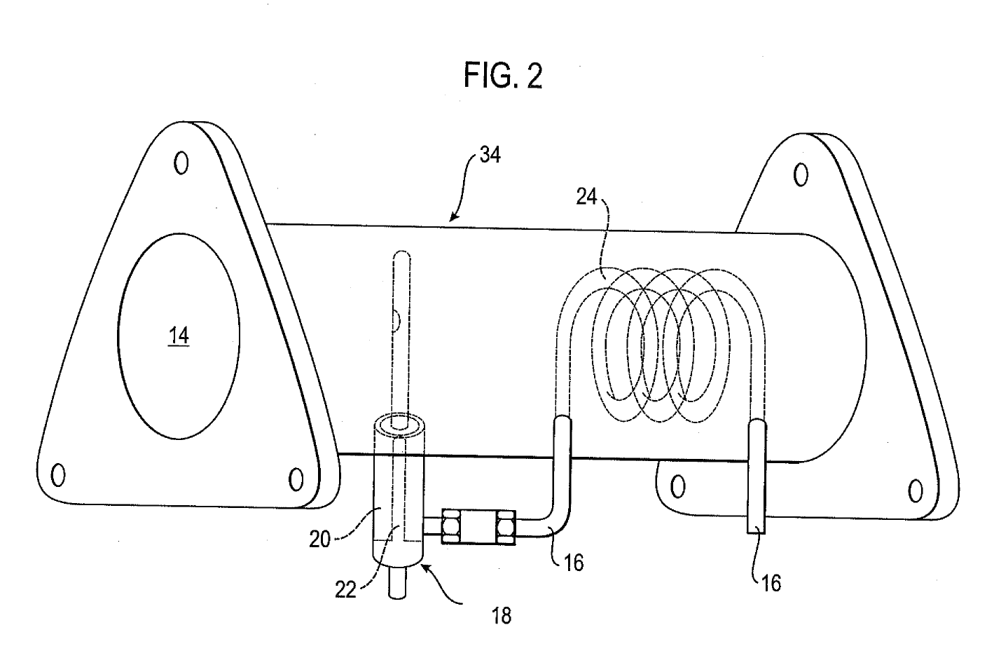

In the embodiment according to FIG. 2, the heating device for the fuel is integrated into an intermediate flange insert 34. A coiled heat exchanger 24 projecting into the warm air flow heats the fuel. The air flow can in turn be heated for example by the energy downstream of the reformation device or the fuel cell, or the catalytic converter, using a further heat exchanger. The reformation device 12 can possibly also be integrated into the intermediate flange insert 34.

Although an embodiment of this invention has been disclosed, a worker of ordinary skill in this art would recognize that certain modifications would come within the scope of this invention. For that reason, the following claims should be studied to determine the true scope and content of this invention.

1. An assembly for producing a hydrogenous gas, comprising:
a reformation device having a fuel supply, a gas supply, and a catalytic converter;
a vaporization unit arranged upstream of the catalytic converter with respect to a gas flow, the vaporization unit having a heating element arranged in a chamber for vaporizing a fuel, with vapor being guided into the gas flow; and
a preheating device for the fuel arranged upstream of the chamber and configured as a heat exchanger.

2. The assembly according to claim 1, wherein the gas supply is an air supply.

3. The assembly according to claim 1, wherein the heating element is a glow plug.

4. The assembly according to claim 1, wherein the heat exchanger is exposed to the gas flow which passes through the reformation device.

5. The assembly according to claim 4, wherein the heat exchanger is placed in the reformation device.

6. The assembly according to claim 5, wherein the heat exchanger is placed in the reformation device downstream of the catalytic converter.

7. The assembly according to claim 1, wherein the heat exchanger is placed in a region of a fuel cell arranged downstream of the reformation device.

8. The assembly according to claim 1, wherein the heat exchanger is placed in an exhaust branch of a combustion engine.

9. The assembly according to claim 1, wherein at least one control is provided which controls a heat quantity released by the heating element that is required for vaporization, wherein the control determines the heat quantity based on a fuel mass flow and a fuel temperature.

10. The assembly according to claim 9, including a temperature sensor coupled to the control and being located between the heat exchanger and the heating element, the heat quantity being determined based on the data acquired by the temperature sensor.

11. The assembly according to claim 1, wherein an ignition device is provided between the vaporization unit and the reformation device.
